(19) United States
(12) Patent Application Publication
(10) Pub. No.: US 2009/0014025 A1
(43) Pub. Date: Jan. 15, 2009

(54) DEVICE FOR CLEANING INTERDENTAL SPACES

(75) Inventors: Vyacheslav Mikhailovich Lyulyev, Moscow (RU); Sergey Maikovich Pavelko, Tver (RU); Svetlana Ivanovna Shkurenko, Tver (RU)

Correspondence Address: DUANE MORRIS LLP - Philadelphia;IP DEPARTMENT, 30 SOUTH 17TH STREET, PHILADELPHIA, PA, 19103-4196, US

(73) Assignees: Vyacheslav Mikhailovich Lyulyev, Moscow (RU); Svetlana Ivanovna Shkurenko, Tver (RU)

(21) Appl. No.: 12/239,168

(22) Filed: Sep. 26, 2008

Related U.S. Application Data
(63) Continuation-in-part of application No. PCT/RU06/00153, filed on Mar. 31, 2006.

(30) Foreign Application Priority Data
Mar. 31, 2006 (RU) PCT/RU06/000153

(51) Int. Cl. A61C 15/04

(52) U.S. Cl. 132/324

(57) ABSTRACT

Individually packaged coils of dental floss are packed in a succession of separable. The package can be a tubular sheet structure with segments formed between transverse lines of attachment at which the floss is cut and the segments are separable by a lateral perforation. Tearing a separated single segment in half allows the floss to be extended between the free ends of the floss, each captured in the remaining portions of the weld lines at opposite ends of the segment. The segments can be formed from two facing sheets with welds along both lateral edges and across the transverse lines between segments. Alternatively, an integral sheet can be folded to form one lateral edge and attached at the other edge. The sheet material can be polymer coated paper or a transparent plastic.

### CROSS REFERENCE TO RELATED APPLICATION

This is a continuation in part of international application PCT/RU2006/000153, filed Mar. 31, 2006, and designating the United States.

### FIELD OF THE INVENTION

The invention concerns oral hygiene devices for cleaning inter-dental spaces and in particular concerns lengths of dental floss packaged in a folded tube. The tube is segmented to carry single use loops of floss between spaced lines of separation. A tear notch is disposed between the separation lines.

### RELATED ART

Devices have been attempted for cleaning inter-dental spaces, comprising containers for coiled floss. Commonly marketed dental floss containers generally have some sort of body for feeding lengths of floss from a supply, and means associated with a holder and a working part, for attaching an end of the floss.

These means can be arranged at an opening of a holder provided in the floss storing unit. Such means are arranged where the base of an elongated basic wedge joins the holder, the floss storage unit being arranged on the outer surface of the holder and connected to the base of an additional elongated wedge fixed without tension, as a floss end stop, as in RU Patent No. 2077872, dated Oct. 18, 1993.

A device for cleaning inter-dental spaces comprising floss packed sealingly with end portions for holding it is arranged in a package with sewn-on an additional support as disclosed in RU Patent No. 2257867, dated Dec. 29, 2003).

Prior art technical solutions are characterized by relatively complicated technological processes for packaging the floss. The strength and other properties of the floss are impaired during the sewing of the support with the floss and due to a “peeling effect,” involving formation of dust from the floss, which dust may be left in the inter-dental spaces violating hygienic standards, and even enter the gastrointestinal tract.

According to the present disclosure, an improved floss packaging technique involves a simplified technological process for packaging the floss, ensuring sealed and hygienic properties of the floss through transportation and potentially long storage to the point of use, eliminating the “peeling effect,” and breaks, sharp bends and the like, to preserve the elasticity of the floss, and in general to provide for a packaging structure that on the one hand is technologically simple, and on the other hand provides certain conveniences that facilitate access to the product and enable the floss to be appropriately manipulated by the user.

Floss packaging attempts comprising short coils of floss packaged individually, are disclosed, for example, in U.S. Pat. Nos. 4,986,289 and 5,322,077, among others. These products are examples of prior attempts to package one-use short lengths of floss in containers that protect the floss from dust and dirt during storage and shipment. The product is produced by providing indefinitely elongated sources of floss and of two sheets of material that will face opposite sides of the package. Single use lengths of floss are coiled and spaced by short straight lengths of floss. The successive coils and intermediate straight lengths are captured between the facing sheets, which can comprise paper material, for example. The facing sheets can be adhered to one another linearly along both opposite edges, and also transversely exclusively at the straight lengths of floss. The packaging also can be perforated or otherwise weakened transversely at the straight length zones, and the floss also can be cut at these zones, so as to divide the successive still-attached product into individual packages.

The product can be separated into individual use segments by ripping across the transverse weakened lines (e.g., perforations). When ready to use the product, the user tears open the package in one direction or another and obtains access to the floss. The floss is pulled out from the coil, typically by pulling the ends that were captured between the facing sheets at the weakened lines, and elongated for manual insertion into spaces between the teeth.

### SUMMARY OF THE INVENTION

It is an object of the invention to achieve optimally simplified manufacture of conveniently deployed individual portions of dental floss. This object is achieved in a device for cleaning inter-dental spaces, comprising a floss in a sealed pack wherein opposite ends extending from a coil of floss are fixed at perforations or similarly weakened lines between the individual portions, and a tear line for opening each of the packages is preferentially defined by a transverse notch spaced between successive weakened lines between the packages. As a result, when the packages are torn open and the covering material at the ends of the packages are pulled away from one another to extend the floss from the coil, the free ends of the floss are captive in the separated portions of the packaging material, forming tabs.

According to another development, the sealed package is embodied in the form of a two-layer strip subdivided into individual sections, each of which is welded along the circumference thereof by means of a weld seam and which are separated from each other by a weakened line, and the floss is arranged in each section in the form of a plurality of windings, and the end portions of the floss are led out of each section to the opposite sides of the package in such a way that the floss is able to pass from one section to another, and the floss is pre-cut at the passing point.

Advantageously, however, the package can be made from a single sheet of facing material rather than two facing sheets. The single sheet is twice the lateral width of the package and is folded along a longitudinal line such that a generally tubular enclosure is made but requires that the package be welded only along one lateral edge, and also transversely at spaced lines that form the borders between individual packages and also tabs that capture the fee ends of the floss

As made in two layers, preferably as one folded structure, both layers of the sheet material of the package are made of polymer coated paper. Additionally or alternatively, one layer of the package can comprise a paper or coated paper and the other can comprise a transparent thermo-packaging material enabling the user to see the coil of floss.

The tear mark or notch provided on one or both of the lateral sides of each section enables the package to be separated transversely at the coil. Preferably, the tear mark comprises a notch on the lateral edge that is opposite from the elongated longitudinal fold. Thus in manufacturing, the notch can extend laterally inwardly, by only a portion of the lateral thickness of the weld seam. Thus the floss is fully enclosed in packaging until the individual package is torn open.

Additional aspects will be apparent from the following discussion of exemplary embodiments.

### BRIEF DESCRIPTION OF THE DRAWINGS

There are shown in the drawings a number of embodiments and aspects of the invention as presently preferred. It should be appreciated that the invention is not limited to the precise arrangements and combinations of aspects that are presented as examples, and is capable of additional embodiments in accordance with the invention as claimed. In the drawings,

FIG. 1 schematically shows the general view of the inventive device for cleaning inter-dental spaces.

FIG. 2 shows an individual package before tearing open.

FIG. 3 illustrates manufacturing aspects including forming a package with an elongated fold opposite from an edge seam.

FIG. 4 shows the package as in FIG. 3.

FIG. 5 shows a package as opened for use.

### DETAILED DESCRIPTION

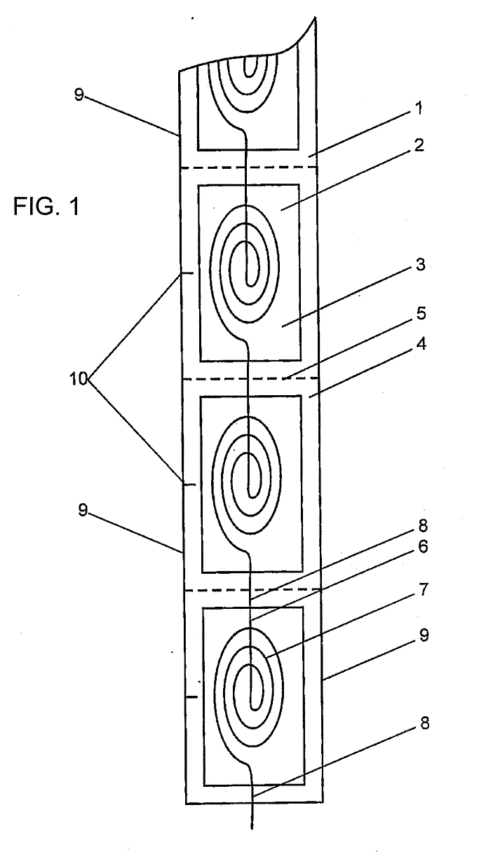

A device for cleaning inter-dental spaces is shown throughout the drawings using the same reference numbers to identify the same elements in the successive embodiments and views. Referring to FIG. 1, the device comprises a sealed package 1 embodied in this example as a two-layer strip 2, enclosing spaced coils of dental floss in individual packaging sections 3.

Each section 3 is welded by means of a weld seam 4 along at least part of its circumference as necessary to form a substantially complete enclosure for the floss, but for the extreme ends of the floss that continued from one section to the next during manufacture but are cut between the sections at transverse weakened lines 5. At these lines 5 separating the packaging into individual segments, the sheets of material on opposite sides of the package are affixed, for example by use of adhesive or more preferably by heat or ultrasonic welding of material coated with or infused with a thermoformable plastic. The weakened line 5 can be perforated or pinched or similarly weakened, preferably along a line that is spaced from the edges of the weld, so that when the weakened line 5 is torn across, the free ends of the floss in both adjacent segments remain captive in the portion or the weld line that remains with their respective segments.

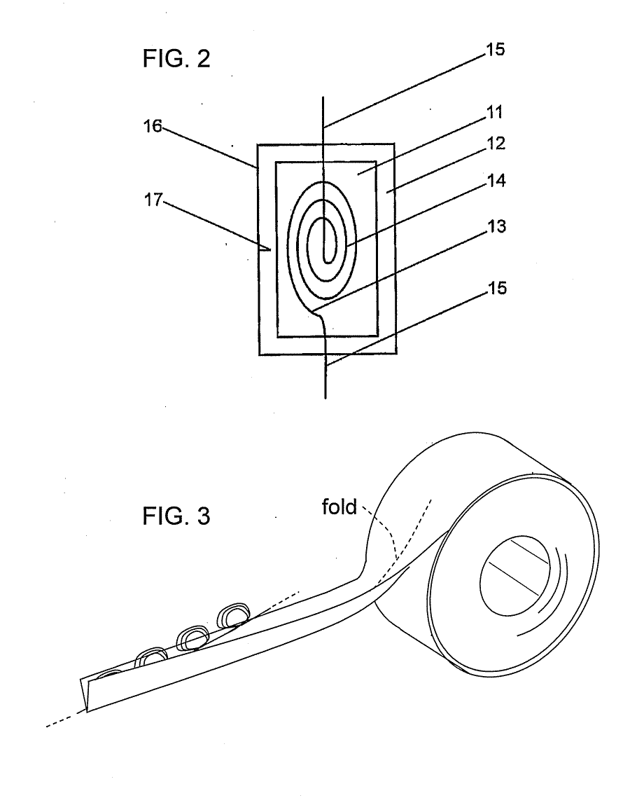

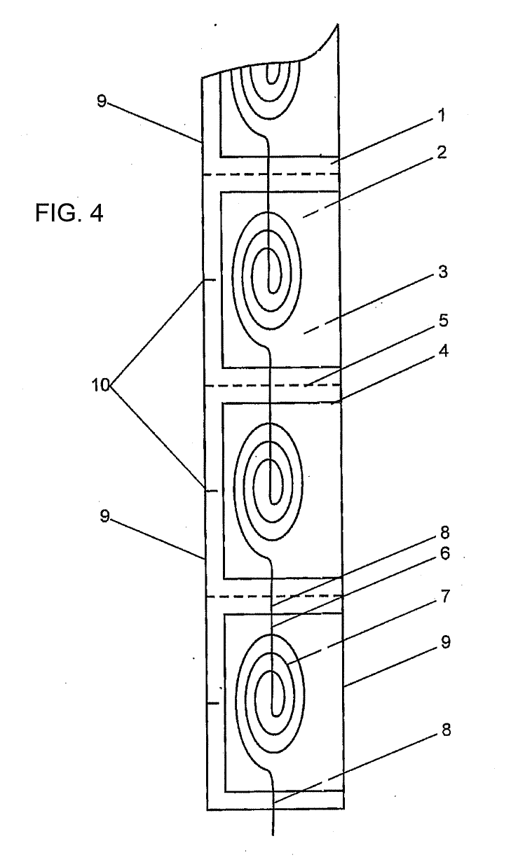

In the embodiment shown in FIGS. 1 and 2, the weld seams are formed along both opposite lateral edges 9. In another embodiment shown in FIG. 3, one of the lateral edges comprises a fold that need not be welded, but can optionally be welded as in FIG. 1 to reinforce and stiffen the segments.

Floss 6 is placed in each section 3 between the layers in the form of a plurality of coils with at least one and preferably several substantially overlapped windings 7. The end portions 8 of the dental floss 6 are led out of each section to the opposite sides of section 3 and are arranged in the package in such a way that they continue or pass from one section to the next. The dental floss 6 is cut at the passing point to facilitate separation of the sections. Cutting of the floss 6 at a point within the thickness of the weld line can be part of forming the weakened line 5 for separating the segments into individual units. An advantageous length for the floss is 25-26 cm, which is an optimal value for one-time use after which the package and floss are discarded. The even arrangement of the windings 7, without sharp folds, preserves the quality of the dental floss and facilitates insertion between and movement in inter-dental spaces.

For convenience when opening the device, a tear mark 10 is provided in the form of a notch on one of the free sides 9 of each section.

The sealed two-layer package 1 may be made with two layers of polymer coated paper, for example, paper manufactured in accordance with standardized Russian Material Specification No. TU 54-34-003-00334095-98. The sealed two-layer package 1 may be made such that one of the layers consists of paper, for example, paper according to the above-mentioned TU specification, and the other layer consists of a transparent thermo-packaging material manufactured according to standardized Russian Material Specification No. GOST 10354-82.

Stomatological (intra-oral) aspects can be incorporated in the dental floss and/or the packaging, such as various coatings and various additives, fragrances, drug preparations, etc.

The device is used for cleaning inter-dental spaces in the following manner. One section can be separated from the others along the weakened line (e.g., perforation) 5 between the segments. Tearing open is performed along the tear mark 10 on one of the free sides 9 of the separated section between the longitudinally spaced lines 5 that demarcate the segments. This releases the coils of dental floss 6, which can be pulled out and elongated freely while the fixed end portions 8 of the dental floss remain captive in the material at the weld seams 4 of the section. The floss is ready to use and can be manipulated handily using the portions of the paper still affixed to the ends of the floss as finger tabs.

The other sections 3 of the sealed package remain in the device until the next time of use. The device for cleaning inter-dental spaces is compact, easy to manufacture and use, makes it possible to pull out the floss freely without entanglement, preserving the uniformity of action of the therapeutic effect and all the properties of the floss that are relevant for the consumer.

FIG. 2 illustrates a single use package according to the invention, i.e., a package or segment 11 that has been separated from a succession of similar packages or segments as shown in FIG. 1. The device comprises a sealed two-layer package embodied in the form of a section 11. In this case, corresponding to FIG. 1, the package is welded all around its circumference by means of a weld seam 12. The dental floss 13 was placed into section 11 between opposed layers, in the form of a plurality of windings 14. The end portions 15 of the dental floss 13 are led out to the extreme ends of section 11. The length of the floss is 25-26 cm, which is an optimal value for single-time use. The evenly arranged windings 14 without sharp bends preserve the quality of the dental floss. For tearing open the device, a tear starter notch or a mark 10 is provided on at least one of the free sides 16 of each section.

FIGS. 3 and 4 illustrate an alternative embodiment wherein a longitudinal fold closes the packaging on one of the lateral sides, namely the side opposite from the tear starter notch 10. The weld line in this case extends around three sides and the fold closes the fourth side. FIG. 3 shows a stage in manufacture when forming the fold and inserting coils of floss separated by lengths extending from one segment to the next. The closing welds on the side including the tear notch 10 and separating the segments for a space on either side of weakened line 5, are shown in FIG. 4, the reference numbers otherwise corresponding to the elements of FIG. 1.

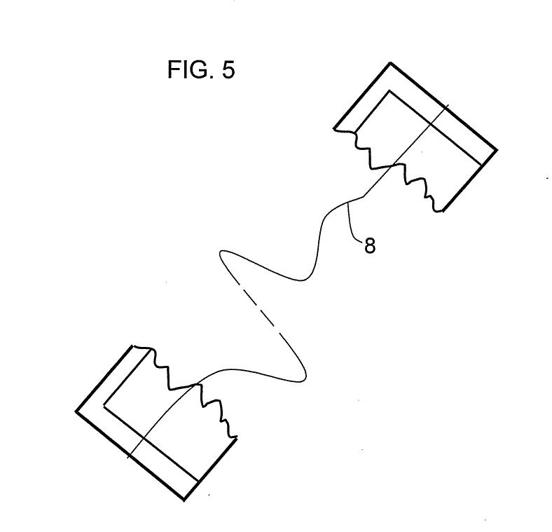

FIG. 5 demonstrates that after tearing a separated segment open from notch 10 across the body of the segment, the floss 8 can be pulled from its coil by extending the floss 8 between the separated ends of the sheet material packaging. In this example, the segment corresponds to those of FIG. 4.

The foregoing discussion and the embodiments illustrated in the drawings illustrate several examples, but it should be appreciated that the invention is not limited to theses examples and may be varied as provided in the attached claims.

We claim:

1. A device for cleaning inter-dental spaces, comprising:
dental floss arranged in a sealed package with end portions for holding the dental floss, wherein the sealed package comprises two layers in a strip adhered along a line at least at one lateral edge, and adhered at spaced transverse lines so as to form individual sections, wherein the sealed packages is separable transversely along a line, the dental floss being arranged in each section in the form of a plurality of windings, and wherein end portions of the floss are led out of each section to opposite ends of the sealed package in such a way that the floss extends between adjacent sections and is pre-cut at a passing point between the adjacent sections.

2. The device of claim 1, wherein both of said two layers of the package comprise polymer coated paper.

3. The device of claim 1, wherein at least one of said two layers comprises a transparent thermo-packaging material.

4. The device of claim 1, further comprising a tear starting mark on at least one lateral side of the individual section.

5. The device of claim 1, further comprising a tear starting mark on at least one lateral side of the individual section.

6. The device of claim 1, wherein the two layers in the strip are adhered along a line at one lateral edge, and are joined at a fold at an opposite lateral edge.

7. The device of claim 6, further comprising a tear starting notch on said one lateral edge, the notch extending part way through a width of a weld line joining the two layers of the strip at said one lateral edge.

8. The device of claim 7, wherein the spaced transverse lines have a weakened line therein, and the dental floss is cut at the weakened line such that free ends of the floss are captured in the spaced transverse lines of adjacent said individual sections.

9. A device for cleaning inter-dental spaces, comprising a dental floss arranged in a sealed package with end portions for holding the floss, wherein in the sealed package comprises a two-layer section welded along the circumference by means of a weld seam, wherein the dental floss is arranged in the section in the form of a plurality of windings, and its end portions are led out to the opposite sides of the package.

10. The device of claim 9, wherein both layers of the package are made of polymer coated paper.

11. The device of claim 9, wherein one layer of the package comprises paper and an other layer of the package comprises a transparent material through which the floss can be seen.

12. The device of claim 9, comprising a tear starting mark on one of two opposite sides of the section.
